(19) United States
(12) Patent Application Publication
(10) Pub. No.: US 2026/0267554 A1
(43) Pub. Date: Sep. 10, 2026

(54) Memory-Governed Admissibility System with Structured Memory Entity-Based Admissibility Constitution and Non-Determinative Artificial Intelligence Structures

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/667,198

(22) Filed: May 4, 2026

(51) Int. Cl. G06F 3/06

(52) U.S. Cl. CPC G06F 3/0655; G06F 3/0622; G06F 3/0673

(57) ABSTRACT

A system is disclosed in which system behavior is constituted exclusively through admissible structural participation of structured memory entities within a system memory domain. The system memory domain maintains admissibility conditions corresponding to allowable fact expressions, relational states, structural participation forms, stored structural relationships, and validated memory states. Artificial intelligence components operate as non-determinative candidate-generating structures that produce representations corresponding to potential system conditions, which are transformed into structured forms and evaluated for admissibility correspondence. Validation structures establish structural correspondence across representations prior to admissibility correspondence. Structured memory entities are admitted into the system memory domain only upon correspondence with admissibility conditions and thereafter participate in system behavior. Communication mechanisms provide information presence without defining behavior, and device-level memory structures provide localized structural availability without independent authority. System behavior is therefore derived from memory-governed structural participation, enabling deterministic and verifiable operation across distributed and heterogeneous environments.

### US PATENT DOCUMENTS

U.S. Pat. No. 8,249,042 B2 08/2012 Sparr et al.
US 2005/0201340 A1 09/2005 Wang et al.
U.S. Pat. No. 7,336,642 B2 02/2008 Rich et al.
U.S. Pat. No. 10,383,069 B2 08/2019 Nguyen-Dang
U.S. Pat. No. 11,265,799 B2 03/2022 Tao et al.
U.S. Pat. No. 10,728,751 B2 07/2020 Lahteenmaki et al.
U.S. Pat. No. 11,206,549 B1 12/2021 Eyuboglu
U.S. Pat. No. 8,532,023 B2 09/2013 Buddhikot et al.
U.S. Pat. No. 8,233,905 B2 07/2012 Vaswani et al.
U.S. Pat. No. 10,379,842 B2 08/2019 Malladi et al.
U.S. Pat. No. 11,082,525 B2 08/2021 Sethuraman et al.
U.S. Pat. No. 10,673,538 B2 06/2020 Pressnitzer et al.
U.S. Pat. No. 10,305,803 B2 05/2019 Fredette et al.
U.S. Pat. No. 8,812,794 B2 08/2014 Aronovich et al.
U.S. Pat. No. 8,255,605 B2 08/2012 Rankin et al.
U.S. Pat. No. 11,646,940 B2 05/2023 Prasad et al.
U.S. Pat. No. 11,348,597 B2 05/2022 Hill et al.
U.S. Pat. No. 9,882,833 B2 01/2018 Mcbride et al.
U.S. Pat. No. 10,705,808 B2 07/2020 Chiosi et al.
U.S. Pat. No. 9,450,817 B1 09/2016 Bahadur et al.
U.S. Pat. No. 10,007,513 B2 06/2018 Malladi et al.
U.S. Pat. No. 10,878,441 B2 12/2020 Hollinger et al.
U.S. Pat. No. 10,179,588 B2 01/2019 Takamatsu
U.S. Pat. No. 11,131,992 B2 09/2021 Du et al.
U.S. Pat. No. 10,769,525 B2 09/2020 Redding et al.
U.S. Pat. No. 10,537,996 B2 01/2020 Egerstedt et al.
U.S. Pat. No. 11,348,073 B2 05/2022 Alvarez
U.S. Pat. No. 10,917,642 B2 02/2021 Tabatabai et al.

### CROSS-REFERENCE TO RELATED APPLICATIONS

This application is related to and incorporates by reference applications within the same patent family directed to memory-prioritized system architectures, admissibility-based structural systems, representation-layer normalization structures, identity continuity structures, bearer abstraction architectures, and governance-conditioned participation systems. Said related applications describe complementary structural aspects including system memory domains, admissibility conditions, structured memory entities, distributed participation structures, and multi-bearer communication configurations, each corresponding to distinct but interoperable layers within a unified memory-governed system architecture.

### PRIOR ART

The references listed below are provided for verification and examination support purposes and correspond to publicly accessible patent documents.

The inclusion of any reference herein is not an admission that such reference is material to patentability, is relevant to the claimed subject matter, or constitutes prior art against the present disclosure.

### BACKGROUND OF THE INVENTION

Existing systems that incorporate artificial intelligence and distributed communication infrastructures typically rely on inferential determination, probabilistic model output, or procedural decision mechanisms to define system behavior. Such approaches treat model-generated outputs, communication-delivered information, or locally stored data as directly actionable, thereby allowing system behavior to be influenced by representations that may not correspond to validated structural conditions.

In distributed and heterogeneous environments, representations of system conditions may be inconsistent across modalities, communication mechanisms, and device-level states. Conventional architectures attempt to resolve such inconsistencies through prioritization, arbitration, confidence scoring, or routing strategies, which introduce variability, non-determinism, and susceptibility to degraded or adversarial conditions.

Furthermore, existing systems lack a unified structural mechanism for distinguishing between candidate representations and admissible system behavior. Artificial intelligence outputs, communication signals, and stored data are often treated equivalently, without a structural boundary defining participation conditions.

Such systems do not establish a system memory domain in which admissibility conditions structurally determine participation, nor do they structurally constrain participation through admissibility-governed memory domains.

As a result, system behavior may be determined by transient or unvalidated representations, leading to inconsistency, reduced reliability, and inability to maintain coherent operation under degraded communication, multi-modal conflict, or distributed execution conditions.

There exists a need for a system architecture in which system behavior is not defined by inference, communication presence, or storage availability, but is instead constituted exclusively through structurally admissible participation within a governed memory domain.

### SUMMARY OF THE INVENTION

The present disclosure describes a system in which system behavior is constituted exclusively through admissible structural participation of structured memory entities within a system memory domain.

A system memory domain is established as a governing structural reference that maintains admissibility conditions corresponding to allowable fact expressions, relational states, structural participation forms, stored structural relationships, and validated memory states. Representations generated by artificial intelligence components, received through communication mechanisms, or maintained within device-level memory structures do not constitute system behavior unless they correspond to said admissibility conditions.

Artificial intelligence components operate as non-determinative candidate-generating structures that produce representations corresponding to potential system conditions. Said representations are transformed into structured forms and evaluated for structural correspondence relative to admissibility conditions maintained within the system memory domain.

Validation structures establish structural correspondence across representations prior to admissibility correspondence, including correspondence across modalities, communication mechanisms, and device-level memory states.

Structured memory entities are admitted into the system memory domain only upon correspondence with admissibility conditions and thereafter participate in system behavior as admissible structural representations. Communication mechanisms provide information-presence structures without defining system behavior, and device-level memory structures provide localized structural availability without independent behavioral authority.

System behavior is therefore derived from memory-governed structural participation rather than inferential determination, communication availability, or data presence, enabling deterministic, reusable, and verifiable operation across distributed, heterogeneous, and degraded environments.

### BRIEF DESCRIPTION OF DRAWINGS

FIG. 1—System Constitution Structure

FIG. 2—Memory and Artificial Intelligence Governance Structure

FIG. 3—Device-Level Memory Structure

FIG. 4—Communication and Validation Structure

### DETAILED DESCRIPTION OF THE INVENTION

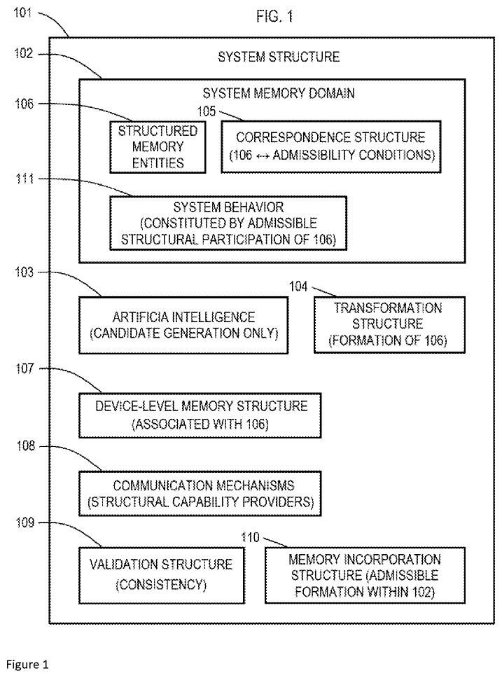

The following figures define constitutional structural relationships corresponding to a memory-governed system in which system behavior is constituted through admissible participation of structured memory entities within a system memory domain. All illustrated elements represent structural existence, admissibility conditioning, structural correspondence, memory participation, and communication capability relationships. No illustrated element represents execution sequence, procedural steps, routing, optimization, or decision-making. The illustrated arrangement represents structural association and constitutional dependency rather than temporal order or sequential processing. All elements illustrated in FIGS. 1-4 constitute a non-separable unified system. No individual element or subset of elements independently defines system behavior. System behavior exists only upon admissible structural participation of structured memory entities within a system memory domain.

### FIG. 1—System Constitution Structure (101-111)

A system structure 101 constitutes a top-level structural domain within which all subordinate elements exist. Within said system structure 101, a system memory domain 102 exists, said system memory domain maintaining admissibility conditions corresponding to allowable fact expressions, relational states, and structural participation forms, and constituting a primary structural reference domain for admissibility and participation correspondence. At least one artificial intelligence component 103 exists corresponding to candidate output generation. A transformation structure 104 exists corresponding to structural formation of structured memory entities from candidate outputs. A correspondence structure 105 exists between structured memory entities and admissibility conditions maintained within system memory domain 102. Structured memory entities 106 exist within system memory domain 102 as admissible structural representations. A device-level memory structure 107 exists including chip-level memory associated with structured memory entities 106. A plurality of communication mechanisms 108 exist as interoperable bearer capabilities. A validation structure 109 exists corresponding to cross-bearer consistency verification. A memory incorporation structure 110 exists corresponding to admissibility-based incorporation into system memory domain 102. System behavior 111 corresponds to admissible structural participation of structured memory entities 106 within system memory domain 102.

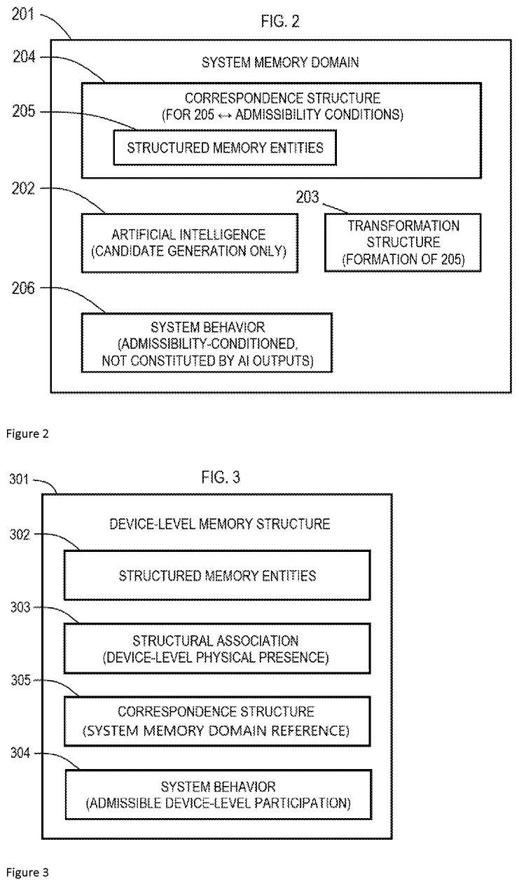

### FIG. 2—Memory and Artificial Intelligence Governance Structure (201-206)

A system memory domain 201 exists corresponding to a structural domain maintaining admissibility conditions including allowable fact expressions, relational states, stored structural relationships, and validated memory states. At least one artificial intelligence component 202 exists corresponding to generation of candidate outputs. A transformation structure 203 exists corresponding to structural formation of structured memory entities from candidate outputs. A correspondence structure 204 exists between structured memory entities and admissibility conditions maintained within system memory domain 201. Structured memory entities 205 exist within system memory domain 201 as admissible structural representations corresponding to minimal validated operational structures and reusable structural forms. System behavior 206 corresponds to admissible structural participation of structured memory entities 205 within system memory domain 201, wherein system behavior is not constituted based solely on candidate outputs.

### FIG. 3—Device-Level Memory Structure (301-305)

A device-level memory structure 301 exists including chip-level memory and embedded memory associated with system components. Structured memory entities 302 exist in association with said device-level memory structure 301. A structural association 303 exists between structured memory entities 302 and said device-level memory structure 301, preserving structural presence at a device-level memory location. System behavior 304 corresponds to admissible structural participation of structured memory entities associated with said device-level memory structure. A correspondence structure 305 exists between structured memory entities 302 and admissibility conditions maintained within a system memory domain.

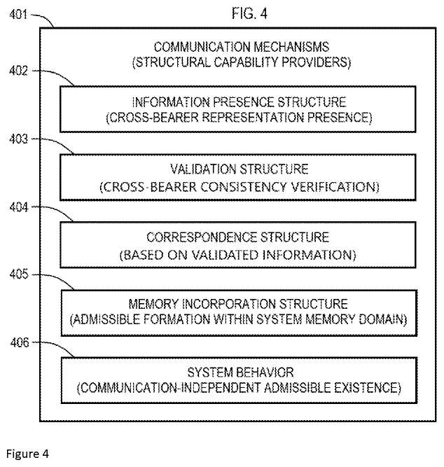

### FIG. 4—Communication and Validation Structure (401-406)

A plurality of communication mechanisms 401 exist as interoperable bearer capabilities, including wireless, non-wireless, and non-electromagnetic propagation mechanisms including acoustic and ultrasonic propagation. A structural association 402 exists corresponding to information presence across said communication mechanisms. A validation structure 403 exists corresponding to cross-bearer consistency verification across independently represented information. A correspondence structure 404 exists between validated information and admissibility conditions within a system memory domain. A memory incorporation structure 405 exists corresponding to incorporation of validated information as structured memory entities upon admissibility correspondence. System behavior 406 corresponds to admissible structural participation of structured memory entities independent of communication pathway selection. Communication mechanisms do not determine system behavior based on routing determination, protocol selection, or transmission success.

The system is constituted as a multi-figure nested constitutional structure in which a system memory domain defines admissibility conditions as a primary structural reference domain, artificial intelligence components correspond to candidate-generating structures, transformation structures correspond to formation of structured memory entities, admissibility correspondence structures define participation boundaries, structured memory entities correspond to admissible structural representations, device-level memory structures provide structural presence including chip-level memory, and communication mechanisms correspond to parallel information-presence and validation-capability structures. System behavior exists only as admissible structural participation of structured memory entities within a system memory domain and is not constituted based solely on candidate outputs or communication pathway selection.

The following description defines constitutional structural relationships corresponding to a memory-governed system in which system behavior is constituted exclusively through admissible structural participation of structured memory entities within a system memory domain. All described elements correspond to structural existence, admissibility conditioning, structural correspondence, memory participation, and communication capability relationships. No described element corresponds to execution sequence, procedural steps, routing, optimization, control determination, or decision-making. Artificial intelligence components correspond to candidate-generating structures and do not define system behavior. Communication mechanisms correspond to information-presence structures and do not define system behavior. Device-level memory structures correspond to localized structural presence and do not independently define system behavior. All elements described herein constitute a unified and non-separable system. System behavior exists only upon admissible structural participation within the system memory domain.

### System Structural Constitution and System Memory Domain

A system according to the present disclosure comprises at least one entity within a system structure governed by a system memory domain. The system memory domain constitutes a primary structural reference domain that defines admissibility boundaries for all system participation. The system memory domain maintains admissibility conditions corresponding to allowable fact expressions, relational states, structural participation forms, stored structural relationships, validated memory states, cross-modal consistency constraints, cross-bearer validation constraints, and system-level admissibility requirements. The system memory domain is not a passive storage repository. It operates as a structural adjudication layer that determines whether any representation—regardless of source—may participate in system behavior. Representations may originate from artificial intelligence, communication systems, sensors, device-level memory, or external systems; however, such representations remain non-participatory unless they correspond to admissibility conditions within the system memory domain. Stored structural relationships include but are not limited to entity-to-entity associations, spatial positioning relationships, temporal dependencies, environmental correlations, signal-state mappings, communication-state conditions, and operational context structures. Validated memory states correspond to previously verified structural configurations that have satisfied admissibility conditions under prior system conditions. These validated states provide a structural baseline for comparison and enable deterministic participation under recurring or equivalent conditions. All subordinate system components exist in structural relation to the system memory domain. No component independently determines system behavior.

### Artificial Intelligence Candidate-Generation Structure

Artificial intelligence components exist as candidate-generating structures capable of producing candidate representations across multiple modalities and analytical domains. Such components may include perception systems, signal-processing systems, classification models, anomaly detection systems, relational inference systems, predictive systems, situational analysis systems, and language-processing systems. The system does not constrain the architecture, training method, modality, or inference technique of artificial intelligence components. Multiple AI systems may operate concurrently and independently. Outputs generated by artificial intelligence correspond to candidate representations. These representations may include detections, classifications, correlations, predictions, inferred relationships, anomaly signals, situational hypotheses, and environmental interpretations. Such outputs do not constitute system behavior and are not treated as factual system states. They remain candidate hypotheses subject to structural validation. Artificial intelligence does not determine system behavior. Instead, it provides candidate structures that must undergo transformation and admissibility evaluation within the system memory domain. Where multiple AI components generate conflicting or divergent outputs, such differences do not require arbitration or selection. Each output remains a candidate representation, and admissibility correspondence determines whether any output may participate.

### Transformation Structure and Formation of Structured Memory Entities

A transformation structure exists to convert candidate representations into structured forms suitable for admissibility evaluation. The transformation structure extracts and encodes admissibility-relevant relationships, including relational, spatial, temporal, contextual, and historical dependencies. Representation-specific variability, including model-specific encoding, noise, or modality-dependent characteristics, may be removed or normalized. Structural features relevant to admissibility are preserved. The transformation structure maps candidate outputs into structured representations that correspond to potential structured memory entities. These representations are not yet admissible and require validation against system memory domain conditions. Examples include transformation of classification outputs into relational state structures, transformation of signal anomalies into temporal-signal relational structures, and transformation of perception outputs into spatially and contextually bound entity relationships.

### Structured Memory Entities

Structured memory entities correspond to memory-resident structural representations capable of admissible participation within the system. A structured memory entity is distinct from raw data, model output, or communication payload. It preserves relationships among system facts, states, and conditions in a form suitable for structural participation. Structured memory entities may correspond to minimal validated operational structures, representing the smallest structural configuration required for admissible participation under specific conditions. They may also correspond to reusable structural forms capable of participating across multiple conditions exhibiting structural similarity or admissibility equivalence. Structured memory entities may exist in multiple representations including graph structures, relational tables, vector representations, symbolic structures, distributed memory constructs, or hardware-level encoded forms. Each structured memory entity may maintain lineage metadata linking its origin, transformation history, validation state, incorporation conditions, and associations with other memory entities. Lineage corresponds to reconstructable consistency with validated memory states maintained within the system memory domain and is not established by trace logs, event histories, or model-internal attribution mechanisms.

### Admissibility Correspondence

Admissibility correspondence defines the structural relationship between candidate representations and system admissibility conditions. A representation corresponds to admissibility when its structural relationships align with stored structural relationships, validated memory states, cross-modal consistency, cross-bearer consistency, temporal coherence, spatial compatibility, and system-level constraints. Admissibility correspondence is not procedural and does not require step-based evaluation. It is defined by structural compatibility within the system memory domain. Representations that fail to correspond remain outside system behavior regardless of origin or availability.

### Memory Incorporation Structure

A memory incorporation structure governs admission of structured memory entities into the system memory domain. Incorporation corresponds to structural admission rather than storage. Representations may be stored without being admissible; only those satisfying admissibility correspondence become structured memory entities capable of participation. Once incorporated, structured memory entities may participate in system behavior, maintain lineage, and serve as reusable structures.

### Device-Level Memory Structure

Device-level memory structures exist across system nodes including chip-level memory, embedded memory, edge-node memory, and distributed node memory. Structured memory entities may be locally stored and made available for admissible participation under corresponding conditions. Device-level memory provides localized structural availability enabling system operation under degraded or disconnected communication conditions. Local presence of structured memory entities does not override admissibility conditions, which remain governed by the system memory domain.

### Communication Mechanisms as Bearer Capabilities

A plurality of communication mechanisms exists within the system as interoperable bearer capabilities. Said communication mechanisms correspond to mechanisms by which information becomes present across system entities, nodes, and environments, without defining system behavior. The plurality of communication mechanisms may include, but is not limited to, wireless communication, non-wireless communication, electromagnetic communication, non-electromagnetic communication, radio-frequency communication, optical communication, acoustic communication, ultrasonic communication, satellite communication, shortwave communication, long-range radio communication, low-power wide-area communication, Wi-Fi, Wi-Fi mesh, Bluetooth, Bluetooth Mesh, Thread, mobile ad hoc networking, internet-based communication, wired communication, industrial communication interfaces, quantum-capable communication, virtualized communication, simulation-based communication, and future information propagation mechanisms. Each communication mechanism corresponds to an information-presence structure, meaning that it enables availability of representations of system-relevant conditions across spatially distributed entities. The system does not require any single communication mechanism to be authoritative. Communication mechanisms operate as parallel, non-exclusive bearer capabilities. The existence of a representation within a communication mechanism does not imply admissibility, correctness, or participation in system behavior. Different communication mechanisms may correspond to different operational characteristics including bandwidth, latency, reliability, coverage range, energy consumption, susceptibility to interference, environmental dependency, and infrastructure requirements. Representations of the same system condition may exist simultaneously across multiple communication mechanisms in different formats, resolutions, timeframes, and signal characteristics. These differences do not prevent structural correspondence if underlying relational content aligns with admissibility conditions. Communication mechanisms do not determine system behavior based on routing determination, protocol selection, or transmission success.

### Cross-Bearer Validation Structure

A validation structure exists to evaluate structural correspondence across representations received from multiple communication mechanisms. Information corresponding to a system condition may be present across independent communication channels, each providing a distinct representation. These representations may differ in encoding, temporal alignment, fidelity, confidence level, or transmission path. The validation structure evaluates whether these independent representations correspond to a consistent structural interpretation. Cross-bearer validation includes evaluation of relational consistency among represented entities, temporal proximity and synchronization tolerance, spatial coherence across location-based data, compatibility with stored structural relationships, consistency with validated memory states, and alignment with system-level admissibility constraints. Cross-bearer validation does not produce system behavior directly. It produces structurally validated candidate representations that may be considered for admissibility correspondence. A representation validated across multiple independent communication mechanisms may have increased structural confidence, but still requires admissibility correspondence within the system memory domain before becoming a structured memory entity.

### Memory-Driven System Behavior

System behavior is constituted exclusively through admissible structural participation of structured memory entities within the system memory domain. No system behavior is defined by artificial intelligence output, communication pathway selection, routing decisions, signal presence, confidence scores, or isolated representations. Structured memory entities provide the structural basis for behavior formation. Deterministic behavior arises because structured memory entities correspond to validated structural relationships and admissibility conditions rather than probabilistic inference alone. Reusable behavior arises because structured memory entities may correspond to multiple system conditions exhibiting structural similarity. Verifiable behavior arises because structured memory entities maintain lineage, validation state, admissibility correspondence, and relational consistency with stored system memory. The system therefore corresponds to a memory-driven behavior constitution model in which behavior is derived from structured memory participation rather than real-time inference alone.

### Multi-Bearer Structural Configuration and Cross-Domain Information Presence

In a structural configuration of the system, information corresponding to a system-relevant condition may exist simultaneously across multiple communication mechanisms. Each mechanism provides a distinct representation of the same condition, differing in format, signal characteristics, temporal resolution, and data abstraction level. The system establishes structural correspondence across these representations by aligning them at the level of admissibility-relevant relationships. A unified structural interpretation may be formed by mapping independent representations into a common structural framework. This mapping does not replace individual communication mechanisms but aligns them structurally. Such unified representations remain candidates and require admissibility correspondence before incorporation into the system memory domain. This configuration enables the system to operate across heterogeneous communication environments without reliance on any single communication infrastructure.

### Device-Level Memory Continuity and Local Structural Availability

Structured memory entities may exist within device-level memory structures distributed across system nodes. Each node may maintain a subset of structured memory entities corresponding to local operational context, environmental conditions, sensor data, or previously validated system states. Device-level memory enables local structural availability of admissible representations, allowing system behavior to continue under conditions where communication with other nodes or central systems is limited or unavailable. Local structured memory entities remain subject to admissibility conditions and do not independently define system behavior. When communication becomes available, device-level memory structures may correspond to association or reconciliation with other system memory structures through structural correspondence rather than direct synchronization. This enables distributed operation while maintaining system-level consistency.

### Multi-Model Artificial Intelligence Structural Interaction

Multiple artificial intelligence components may operate concurrently within the system, each generating candidate representations corresponding to the same or related system conditions. These components may operate on different data modalities, analytical approaches, or model architectures. Each candidate output is transformed into a structured representation and evaluated independently for admissibility correspondence. The system does not require selection among competing AI outputs. Instead, admissibility conditions determine whether one, multiple, or none of the candidate representations correspond to structured memory entities. Artificial intelligence components therefore contribute to a pool of candidate structures without establishing behavioral authority. Structural interaction occurs through transformation and admissibility correspondence rather than procedural arbitration or model prioritization.

### Structural Reuse and Persistence Across System Conditions

Structured memory entities corresponding to previously validated system conditions may be reused under subsequent conditions exhibiting structural similarity or admissibility equivalence. Such reuse corresponds to persistence of structural relationships rather than caching of outputs or rule execution. Where a current system condition corresponds structurally to a previously validated structured memory entity, that entity may participate directly without requiring new candidate generation. This enables reduction of computational load, increased determinism, and improved consistency across repeated operational scenarios. Persistence of structured memory entities establishes structural inertia within the system, reducing susceptibility to variation caused by changes in input data, communication conditions, or artificial intelligence outputs.

### Degraded Communication Structural Configuration

In a further structural configuration, one or more communication mechanisms within the system may correspond to degraded performance conditions, including but not limited to reduced bandwidth availability, increased latency, intermittent connectivity, signal degradation, partial signal loss, or complete communication unavailability. Such degraded conditions may correspond to environmental interference, infrastructure disruption, adversarial interference, energy constraints, physical obstruction, or system-level operational limitations. Under such degraded communication conditions, structured memory entities that are present within device-level memory structures remain structurally available for admissible participation. The degradation or absence of communication mechanisms does not eliminate the structural existence of structured memory entities, nor does it eliminate their correspondence to admissibility conditions maintained within the system memory domain. System behavior under degraded communication conditions continues to be constituted exclusively through admissible structural participation of structured memory entities that remain locally available and that continue to correspond to admissibility conditions. Communication-derived representations that are unavailable due to degraded communication conditions do not invalidate existing structured memory entities, and the absence of new communication-derived representations does not prevent continued system operation where admissible structured memory entities are present. When communication mechanisms become partially or fully available, newly available representations correspond to candidate representations and may be evaluated through validation structures and admissibility correspondence. Such representations do not automatically modify system behavior and must satisfy admissibility conditions before incorporation. The system therefore corresponds to a configuration in which operational continuity is maintained through structured memory participation rather than through communication availability, such that communication mechanisms correspond to augmentation of information presence but do not define the existence, continuity, or validity of system behavior.

### Cross-Modal Structural Configuration

In a further structural configuration, a system condition may be represented through multiple independent data modalities including visual sensing modalities, signal-based sensing modalities, positional or geospatial modalities, environmental sensing modalities, device-state reporting modalities, operator-input modalities, and other data-acquisition modalities. Each modality produces a representation that may differ in encoding format, temporal resolution, spatial resolution, signal characteristics, reliability, noise characteristics, or abstraction level. The validation structure evaluates structural correspondence among modality-derived representations including relational consistency, temporal alignment, spatial compatibility, and correspondence with validated memory states. A modality-derived representation does not become admissible solely based on modality confidence or signal strength. Admissibility is determined only upon structural correspondence with admissibility conditions. Where multiple modalities produce structurally corresponding representations, such representations may correspond to a candidate structured memory entity subject to admissibility correspondence and incorporation. The system does not require any modality to be authoritative. Structural correspondence across modalities determines admissibility.

### Distributed Memory Domain Structural Configuration

In a further structural configuration, the system comprises a plurality of distributed nodes, each node corresponding to a device-level memory structure capable of maintaining structured memory entities. Each node may maintain a subset of structured memory entities corresponding to local operational conditions, environmental states, sensor-derived information, communication-derived representations, or previously validated structural states. Structured memory entities across distributed nodes correspond to shared admissibility conditions maintained within the system memory domain, even where such entities are not identically stored across all nodes. Each node independently evaluates admissibility correspondence based on locally available structured memory entities and maintains participation within system behavior only upon such correspondence. Structural consistency across nodes is not achieved through centralized synchronization or control, but rather through consistent correspondence with admissibility conditions. Nodes may operate independently under conditions of limited connectivity while maintaining structural coherence with other nodes through shared admissibility definitions. Communication between nodes may enable association of structured memory entities across nodes through structural correspondence, but such communication is not required for local admissible participation.

### Extended Multi-Bearer Validation Across Heterogeneous Environments

In a further structural configuration, communication mechanisms may operate across heterogeneous environments exhibiting varying communication characteristics including bandwidth variability, latency variation, intermittent availability, signal degradation, and environmental interference. Said environments may include high-bandwidth local communication networks, low-bandwidth long-range communication systems, intermittent satellite communication links, contested radio-frequency environments, and non-electromagnetic communication channels including acoustic or ultrasonic propagation. Representations corresponding to a system condition may be present across these heterogeneous environments with differing levels of fidelity, temporal alignment, and completeness. The validation structure establishes structural correspondence across such heterogeneous representations by applying admissibility conditions that tolerate temporal offsets, partial representations, and incomplete data, provided relational consistency is preserved. Representations that do not satisfy admissibility correspondence remain non-participatory regardless of communication availability or representation confidence.

### Chip-Level Memory Participation and Embedded Structural Presence

In a further structural configuration, structured memory entities may be maintained within chip-level memory structures associated with sensing devices, communication modules, or processing units. Chip-level memory corresponds to localized structural presence at or near the point of data acquisition or processing. Structured memory entities maintained at chip level may correspond to minimal validated operational structures relevant to local device functionality. The presence of such entities enables immediate availability for admissible participation without requiring retrieval from remote memory structures or re-generation through artificial intelligence components. Chip-level participation reduces dependence on communication mechanisms and reduces latency associated with system behavior formation. However, chip-level presence does not independently define admissibility, which remains governed by system memory domain conditions.

### Structural Consistency and System-Wide Coherence

In a further structural configuration, structured memory entities maintain system-wide structural consistency through continued correspondence with admissibility conditions. Structural consistency does not require identical data representations across nodes or communication pathways but requires preservation of relational integrity and compatibility. Variations in representation detail, signal quality, communication timing, or modality-specific characteristics do not disrupt system behavior where admissibility correspondence is maintained. System-wide coherence is achieved through structural correspondence rather than uniform data representation or centralized synchronization.

### Distributed Structural Consistency Without Centralized Control

In a further structural configuration, system-wide consistency is maintained across distributed nodes without centralized control or decision-making structures. Each node participates through admissible structured memory entities corresponding to system-level admissibility conditions. Nodes independently evaluate admissibility correspondence and maintain participation based on such correspondence. Consistency arises from shared admissibility conditions rather than centralized orchestration or control logic. Communication mechanisms may support association of representations across nodes through structural correspondence but are not required for local admissible participation.

### Final Statement

System behavior is constituted exclusively through admissible structural participation of structured memory entities within a system memory domain, wherein artificial intelligence components correspond to candidate-generating structures, transformation structures correspond to formation of structured memory entities, communication mechanisms correspond to information-presence structures, validation structures correspond to establishment of structural correspondence, and device-level memory structures correspond to localized structural presence, such that no isolated component independently defines system behavior and all participation is governed by admissibility conditions within the system memory domain.

1. A system comprising:
at least one entity;
a system memory domain configured to establish admissibility conditions corresponding to allowable fact expressions, relational states, and structural participation forms;
at least one artificial intelligence component configured to generate candidate outputs;
a transformation structure comprising at least one of software, hardware, or logical processing components configured to convert the candidate outputs into structured memory entities including minimal validated operational structures;
wherein the structured memory entities are incorporated into the system memory domain only upon correspondence to the admissibility conditions;
wherein validation of the candidate outputs is performed based on verifiable conditions comprising stored structural relationships and validated memory states maintained within the system memory domain and external to internal model structure of the artificial intelligence component;
wherein system behavior is constituted through participation of the structured memory entities such that repeated inferential computation is not required for equivalent system conditions;
wherein representations lacking admissibility correspondence do not participate in system behavior;
wherein system validity and lineage are determined by reconstructable consistency with validated memory states maintained within the system memory domain, independent of trace logs, event histories, or model-internal attribution.

2. The system of claim 1, wherein the minimal validated operational structures correspond to reusable behavioral primitives.

3. The system of claim 1, wherein the admissibility conditions comprise governance-defined structural constraints independent of artificial intelligence.

4. The system of claim 1, wherein the transformation structure extracts structural representations from the candidate outputs.

5. The system of claim 1, wherein the structured memory entities are reusable across multiple operational contexts.

6. The system of claim 1, wherein system behavior corresponds to structural participation of the structured memory entities based on validated memory states.

7. The system of claim 1, wherein the at least one artificial intelligence component corresponds to a candidate-generating structure and does not define system behavior.

8. A system comprising:
at least one entity;
a system memory domain configured to define admissibility conditions corresponding to allowable fact expressions, relational states, and structural participation forms;
device-level memory including chip-level memory;
at least one artificial intelligence component configured to generate candidate outputs;
wherein structured memory entities corresponding to system behavior are stored at the device-level memory;
wherein the structured memory entities are derived from candidate outputs generated by the artificial intelligence component and transformed into minimal validated operational structures;
wherein the structured memory entities are incorporated into the system memory domain upon correspondence to the admissibility conditions;
wherein system behavior is constituted through admissible structural participation of the structured memory entities stored in the device-level memory as participation-defining elements rather than as stored data accessed by instruction-based processing;
wherein the structured memory entities enable participation without requiring repeated inferential recomputation for equivalent system conditions.

9. The system of claim 8, wherein the device-level memory comprises embedded memory within processing hardware.

10. The system of claim 8, wherein the structured memory entities are directly accessible for participation without intermediate recomputation.

11. The system of claim 8, wherein the structured memory entities correspond to reusable behavioral primitives.

12. The system of claim 8, wherein the structured memory entities maintain lineage metadata corresponding to origin, transformation history, and validation state.

13. The system of claim 8, wherein the structured memory entities are configured for reuse across repeated operational conditions exhibiting structural similarity.

14. A system comprising:
at least one entity;
a system memory domain;
structured memory entities;
a plurality of communication mechanisms configured to operate as interoperable bearer capabilities within a unified communication framework;
wherein the plurality of communication mechanisms include wireless, non-wireless, and non-electromagnetic communication resources including acoustic, ultrasonic, or other non-electromagnetic propagation mechanisms operable across short-range, mid-range, and long-range communication domains;
wherein the communication mechanisms operate concurrently or selectively under varying operational conditions independent of any single network dependency;
wherein representations corresponding to system conditions are present across multiple communication mechanisms and are evaluated through a validation structure establishing cross-bearer structural correspondence;
wherein the communication mechanisms do not define system behavior but participate as propagation and validation capabilities for structured memory-based participation;
wherein verified information is incorporated into the system memory domain as structured memory entities upon admissibility correspondence;
wherein the structured memory-based participation is dependent on validated information and not on communication pathway selection;
wherein participation of the communication mechanisms is independent of routing determination, protocol selection, or transmission success.

15. The system of claim 14, wherein the plurality of communication mechanisms includes radio-frequency communication, optical communication, acoustic or ultrasonic communication, quantum communication, simulation-based or virtualized communication mechanisms, internet-based communication, satellite communication, and wired or industrial communication interfaces.

16. The system of claim 14, wherein the communication mechanisms operate as a unified communication framework rather than as isolated network layers.

17. The system of claim 14, wherein mesh-based communication frameworks support multi-hop information exchange among distributed nodes under dynamic connectivity conditions.

18. The system of claim 14, wherein long-range and beyond-line-of-sight communication is achieved through cooperation with external communication infrastructures.

19. The system of claim 14, wherein redundant transmission across multiple communication pathways is performed for mission-relevant information.

20. The system of claim 14, wherein the plurality of communication mechanisms comprises any mechanism capable of information propagation between entities regardless of underlying physical medium or technological implementation.
